(19) United States
(12) Patent Application Publication
(10) Pub. No.: US 2006/0155835 A1
(43) Pub. Date: Jul. 13, 2006

(54) SCHEDULABLE NETWORK-ENABLED DEVICE WITH INTERNAL DATA DELIVERY UNIT FOR USE WITH A VISUSAL MEDIUM AND METHODS OF USE THEREOF

(76) Inventor: Babak Forutanpour, Carlsbad, CA (US)

Correspondence Address: BABAK FORUTANPOUR, 6818 CORTE DIEGO, CARLSBAD, CA, 92009, US

(21) Appl. No.: 10/905,578

(22) Filed: Jan. 12, 2005

(51) Int. Cl. G06F 15/16; G06F 15/173

(52) U.S. Cl. 709/223; 709/217; 709/224

(57) ABSTRACT

The present invention generally relates to network-enabled devices, and particularly to a schedulable network-enabled device and methods of use thereof. The present invention is particularly adaptable to provide a fully self-contained device that can be scheduled by an operator that for some future time(s), to automatically connect to a remote server to download, store and deliver data on a visual medium.

### BACKGROUND OF INVENTION

1. Field of the Invention

The present invention relates generally to the field of network-enabled devices, and particularly to a schedulable network-enabled device and methods of use thereof.

2. Background of the Invention

At the present time, access to current news and information from the Internet is only available to individuals who have access to an Internet-enabled personal computer (PC), laptop computer, personal digital assistant (PDA), or similar computing device. The technical skills and finances required to select, purchase, setup and network such devices to the Internet is not an attribute every consumer possesses. Furthermore, the time it take to power-on such devices coupled with the time some must wait while the device's modem dials and connects to their Internet service provider (ISP), e.g. AOL, MSN or Earthlink, makes accessing the desired information too time consuming for some, especially during the morning hours where many are in a rush as they prepare for work, class, or scheduled appointment. Many simply wait until they arrive at their destination or some other locale where easy access to the Internet is available.

It would be desirable to have an inexpensive and simple-to-use device that could provide instant access to the Internet at one or more scheduled times. Currently, commercially available devices that can be scheduled to provide information retrieved from the Internet are network-enabled alarm clocks that deliver the information using the device's speaker. Such devices do not consider the abundance of information that users may want as they being their day, and that the human body has evolved to process information more quickly visually than aurally. Furthermore, such devices do not recognize that users may wish to have access to this information in areas other than the bedroom, where alarm clocks are most commonly placed, generally tethered to their power source.

From the foregoing, it can be appreciated that it would be desirable to have a device that is compact, inexpensive, and easy-to-use, which in order to provide its user instant access to personalized news and information from the Internet, can be scheduled to automatically contact a remote server to download and provide said data quietly on a visual medium that is both portable and low cost. The present invention addresses the existing problems and provides related benefits.

### SUMMARY OF INVENTION

The present invention generally relates to network-enabled devices, and particularly to a schedulable network-enabled device and methods of use thereof. The present invention is particularly adaptable to provide a fully self-contained device that can be scheduled by an operator that for some future time(s), to automatically connect to a remote server to download, store and deliver data on a visual medium. The present invention recognizes that network enabled devices can be made more compact, inexpensive, and easy-to-use, that can be scheduled to automatically contact a remote server to download and provide personalized news and information quietly on a visual medium that is optionally portable and low cost.

A first aspect of the invention includes a schedulable device including a housing; a power supply; a schedulable timer; optionally one or more switches/keys; memory means; an internal visual means for displaying of information; a network interface unit connected to a network; a central processing unit interconnected to the power supply, the schedulable timer, the memory means, the means for displaying information, and the network interface unit; wherein, at a preset time, the schedulable timer triggers the central processing unit to cause the network interface unit to retrieve specified data from a remote server through the network and download the specified data in the memory means and display the specified data using the means for displaying information including an internal data delivery unit and a visual medium.

A second aspect of the present invention includes a method of retrieving specific information from a network including the steps of: providing the schedulable device of the first aspect of the present invention (above); providing one or more unique identification numbers, wherein the central processing unit identifies itself to the remote server using one or more unique identification numbers and the server queries its records for the data associated with each unique identification number and provides the data to be downloaded by the schedulable device; downloading said data from said remote server; and displaying said data on said means for displaying information including an internal data delivery unit and a visual medium.

A third aspect of the present invention includes a method of retrieving specific information from a network comprising the steps of: providing the schedulable device of the first aspect of the present invention (above); connecting the schedulable device to a personal computer in order to program the schedulable device with sources of desired information; wherein, the schedulable device utilizes programmed sources to connect to and download said data from one or more remote servers; and display said data on said means for displaying information including an internal data delivery unit and a visual medium.

### BRIEF DESCRIPTION OF DRAWINGS

FIG. 1 is a simplified perspective view of a self-contained alarm clock device with internal printer according to an embodiment of the present invention including the remote proxy server and several data sources, all connected via two separate networks.

FIG. 2 is a simplified electronic schematic drawing of a self-contained alarm clock device with internal visual data delivery unit according to an embodiment of the present invention.

FIG. 3 is a simplified perspective view of a high-resolution thermal printer for use with loadable rolled paper suitable for use in the present invention.

FIG. 4 illustrates a preferred mode of user operations when registering desired news sources with proxy server in accordance with some of the aspects of the present invention.

FIG. 5 is a simplified perspective view of a self-contained alarm clock device with internal projector according to an embodiment of the present invention including the remote proxy server and data sources, all connected via two separate networks.

FIG. 6 is a simplified perspective view of a self-contained alarm clock device with internal data delivery unit for use with a portable electronic display means according to an embodiment of the present invention including the remote proxy server and data sources, all connected via two separate networks.

### DETAILED DESCRIPTION

The present invention is particularly adaptable to provide a fully self-contained device that can be scheduled by an operator that for some future time(s), to automatically connect to a remote server to download, store and deliver data on a visual medium. The present invention recognizes that network enabled devices can be made more compact, inexpensive, and easy-to-use, that can be scheduled to automatically contact a remote server to download and provide personalized news and information quietly on a visual medium that is optionally portable and low cost.

As a non-limiting introduction to the breadth of the present invention, the present invention includes several general and useful aspects, including:

1. A schedulable device comprising:
a housing;
a power supply;
a schedulable timer;
memory means;
an internal visual means for displaying of information comprising an internal data delivery unit and a visual medium;
a network interface unit connected to a network;
a central processing unit interconnected to the power supply, the schedulable timer, the memory means, the means for displaying information, and the network interface unit;

wherein, at a preset time, the schedulable timer triggers the central processing unit to cause the network interface unit to retrieve specified data from a remote server through the network and download the specified data in the memory means and deliver the specified data to be displayed on the visual medium by way of the internal data delivery unit.

2. A method of retrieving specific information from a network comprising the steps of:
(1) providing the schedulable device of the first aspect of the present invention (above), optionally including an alarm clock;
(2) providing one or more unique identification numbers, wherein the central processing unit identifies itself to the remote server using one or more unique identification numbers and the server queries its records for the data associated with each unique identification number and provides the data to be downloaded by the schedulable device;
(3) downloading the data from the remote server; and
(4) displaying the data on the means for displaying information.

3. A method of retrieving specific information from a network comprising the steps of:
(1) providing the schedulable device of the first aspect of the present invention (above) optionally including an alarm clock;
(2) connecting the schedulable device to a personal computer in order to program the schedulable device with sources of desired information; wherein, the schedulable device utilizes programmed sources to connect to remote server(s);
(3) downloading the data from said remote server(s); and
(4) displaying the data on the means for displaying information.

Further objectives and advantages of the present invention will become apparent as the description proceeds and when taken in conjunction with the accompanying drawings. To gain a full appreciation of the scope of the present invention, it will be further recognized that various aspects of the present invention can be combined to make desirable embodiments of the invention.

Unless defined otherwise, all technical and scientific terms used herein have the same meaning as commonly understood by one of ordinary skill in the art to which this invention belongs. Where a term is provided in the singular, the inventor also contemplates the plural of that term. The nomenclature used herein and the procedures described below are those well known and commonly employed in the art.

1. A Schedulable Network-Enabled Device

The present invention includes a network-enabled schedulable device, which is fully self-contained and can be scheduled by an operator to automatically connect to a remote server to download, store, and deliver data using an internal data delivery unit for use with a visual medium.

The present invention includes a schedulable device including a housing, which can be made of any rigid material capable of housing the present invention. The material from which the housing may be made of, but are not limited to, plastic, wood, metal, glass or a combination thereof. The present invention also includes memory means, such as but not limited to, random access memory (RAM), read only memory (ROM), floppy disk, hard disk, removable storage media such as but not limited to SmartMedia®, Compact Flash®, CD and DVD disks. The present invention also includes a power supply, which may be connected to a power source, such as but not limited to, AC/DC current or a battery.

The present invention also includes a schedulable timer, such as but not limited to a clock that can be scheduled to trigger an event at one or more scheduled times, and/or a countdown timer that can be scheduled to trigger an event after a certain amount of time has elapsed or trigger an event instantaneously.

The present invention also includes an internal visual means for displaying of information, which can be any means capable of visual display of information on a visual medium, for example, a printer (such as SiPix® compact 400 dots-per-inch thermal printer model Pocket Printer A6), light emitting diode (LED), liquid crystal display (LCD), removable LCD (such as that belonging to any standard personal digital assistant), light projector (such as Boxlite® XD-25m projector), cathode ray tube, high-definition television display, electronic paper (such as E Ink® character and segmented display cell technology).

The data delivery unit of the present invention may consist of a connection port or wireless transmitter such as for example, infrared, Bluetooth, 802.11b/g, such that it delivers data to said visual medium.

The present invention also includes a network interface unit connected to a network, such as for example, a modem with automatic dialer, cable, DSL, or wireless network technology such as for example wireless phone, satellite, radio, WiFi, or 802.11b/g, or PC connection, such as for example, universal serial bus (USB), or FireWire.

The network interface unit of the present invention may be optionally connected to a phone line, wherein the network interface unit detects the area code of the phone line and connects to a remote server in the least expensive manner, such as connecting to a remote server having the same area code as the phone line being used.

The present invention also includes a central processing unit (CPU) interconnected to the power supply, the schedulable timer, optional switches/keys, the memory means, the means for displaying information, and the network interface unit; wherein, at a preset time, the schedulable timer triggers the central processing unit to cause the network interface unit to retrieve specified data from a remote server through the network and download the specified data in the memory means and display the specified data on the means for displaying information. Preferably, the CPU of the present invention is able to resize any incoming data from the remote server and present the resized data on the means for displaying of information.

The present invention may optionally include other additions such as but not limited to, an alarm clock having an audible alarm that can be set and function separately from the schedulable timer of the present invention. The present invention may also include one or more audiovisual means such as for example, AM/FM radio, cassette player, compact disk player, DVD player, VCR, television, MP3 player or any other audiovisual means.

Optionally, the manufacturer of the device of the present invention may provide the user of said device with one or more unique alarm identification numbers to facilitate user-customizable data retrieval by said device. List of unique identification numbers may be pre-programmed into said device, for example by the manufacturer at the time of manufacturing, or printed by the manufacturer and provided to the user such that user can program any similar said device. For example, guest at hotel or hospital can program loaned said device with personal unique alarm identification number when scheduling event in order to receive desired data when away from home.

Each unique alarm identification number can be associated with one or more data sources, such as an Internet website Uniform Resource Locator (URL), wherein the schedulable device of the present invention retrieves the data associated with said source of data. Below we discuss two methods of associated data or sources of data with each unique alarm identification number.

II. A Method of Retrieving Information from a Network

The present invention includes a network-enabled schedulable device as described above, which is fully self-contained and can be scheduled by an operator to automatically connect to a remote server to download, store, and deliver data using an internal data delivery unit for use with a visual medium.

One method of use of the device of the present invention includes providing one or more unique identification numbers, wherein the central processing unit of the network enabled schedulable device identifies itself to the remote server using the unique identification number or numbers, at which time the remote server queries its records for the data or provides a list of network addresses (preferably registered as URLs) to sources for the desired data which are associated with the unique identification number(s) to be downloaded by the schedulable device. The remote server may deliver the desired data to the schedulable device of the present invention or queries sources of data for delivery to the schedulable device, or delivers said address(es) to the schedulable device so that the schedulable device can contact and download the desired data itself from those listed source or sources. The method of the present invention also includes downloading the data on the memory means of the schedulable device from the remote server and displaying the downloaded data on the means for displaying information. The displaying of the specified data can be done, for example, by delivering the specified data to be displayed on the visual medium by way of an internal data delivery unit.

The method of the present invention may also include registering the one or more unique identification numbers as associated with a particular phone number or a network address for authentication purposes.

III. Another Method of Retrieving Information from a Network

The present invention includes a network-enabled schedulable derive as described above, which is fully self-contained and can be scheduled by an operator to automatically connect to a remote server to download, store, and deliver data using an internal data delivery unit for use with a visual medium.

One method of use of the device of the present invention includes connecting the schedulable device of the present invention to a personal computer in order to program the schedulable device with desired information and commands, such as for example, event times for connection, the sources of desired information such as network addresses of data servers managing the desired data, wherein when an event is triggered, the schedulable device uses internal circuitry to connect to the network in order to initiate contact with and download data from the remote data server(s). The method of the present invention also includes downloading the data on the memory means of the schedulable device from the remote server(s) and displaying the downloaded data on the means for displaying information. The displaying of the specified data can be done, for example, by delivering the specified data to be displayed on the visual medium by way of an internal data delivery unit.

### EXAMPLES

### Example 1

### A Schedulable Network-Enabled Device Including an Internal Printer

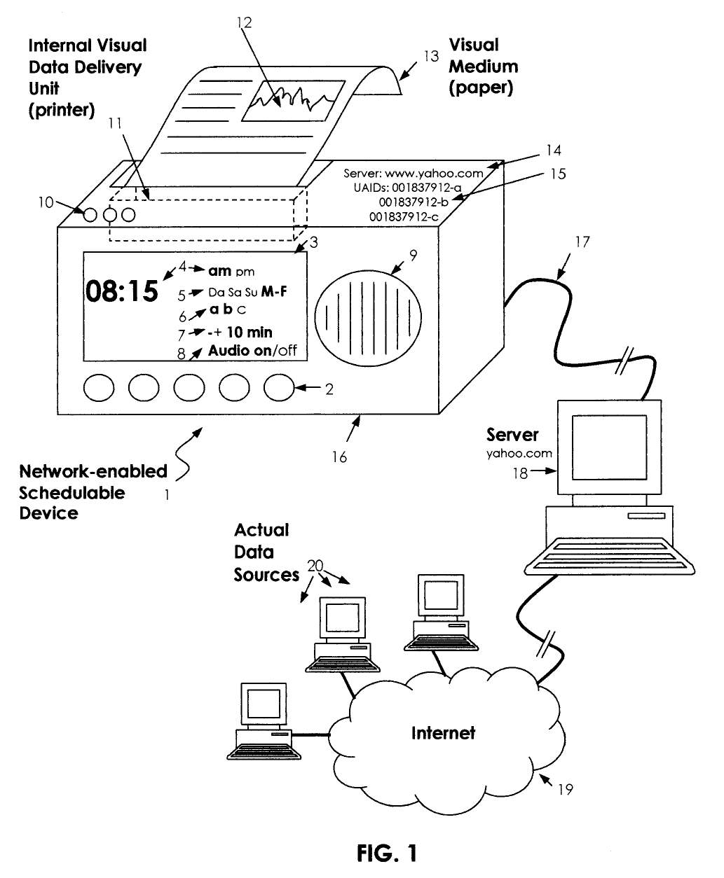

In FIG. 1, an embodiment of the invention is illustrated in simplified schematic form for the purpose of describing the basic concepts of the invention. The apparatus 1 is shown executing a printing sequence of text and image data 12 on medium 13. The data being printed was retrieved by the apparatus 1 from a remote proxy server 18 via a connection over physical connection 17. The light emitting diodes 10 signify if device is connected to proxy server, and whether apparatus is transmitting and/or receiving data. The addresses of systems 20 which actually contain the information desired by the user were pre-registered with the proxy server 18, whose address was known to the user via label 14 printed on housing 16. The data servers 20 are accessible to the proxy server 18 over some network 19. The data servers may or may not be accessible by the apparatus 1 over connection 17.

The housing 16 includes an audio output device, such as at least one speaker 9 or the like, that may be driven by at least one amplifier (not shown). The housing 16 holds a number of switches or keys 2 which may be used to set or select various functions of the apparatus 1. Such functions may include, but are not limited to, setting the clock, scheduling alarm(s), setting timer(s), turning on or off device, turning on or off an alarm, changing the volume, setting a snooze, operate the printer's paper feeding mechanism. If the apparatus 1 has an entertainment unit such as an AM/FM/Satellite radio receiver, TV or CD/DVD/MP3 player, the keys 2 can be used to, for example, to select, play, stop, pause, forward, advance or reverse the audio/video signal.

The housing 16 includes a visual display device 3 such as a conventional light emitting diode (LED) or liquid crystal display (LCD). 4 shows a scheduled alarm time as a combination of hour and minute and “am” or “pm” text. 5 displays the frequency of alarm, where choice “Da” denotes an alarm scheduled for every day of the week, “Sa” denotes an alarm scheduled for Saturdays only, “Su” denotes and alarm scheduled for Sundays only, and “M-F” denotes and alarm for Monday through Thursday only. In this example, an alarm time for “8:15 am occurring every Monday through Thursday” has been set. 6 displays the unique alarm identification numbers (UAID), if any, associated with given audible alarm. The manufacturer of the apparatus 1 provides UAIDs to the user via label 15. UAIDs associate a scheduled alarm time with the content desired for retrieval over some network and subsequent printing. A UAID 15 and associated data, or address to servers 20 which manage desired data, must be registered with server 18 prior to scheduling of alarms. In 6, the “a” displayed is a short form representation of device UAID ending with that letter, or in this example, “001837912-a” from 15. Similarly, an active display of 6 “b” denotes that data for UAID “001837912-b” should also be downloaded. Finally, 7 denotes the number of minutes relative to a scheduled alarm time that device should contact network for delivery of UAID data. At 7, “−” followed by a number denotes said number of minutes prior to set alarm time 4 device should contact server for data. Similarly, a “+” followed by a number denotes the said number of minutes after a scheduled audible alarm time the device should contact server for data. 8 denotes whether alarm should be audible or not. The alarm sound may be a buzzer with a predetermined loudness, a predetermined radio station, a predetermined CD/DVD track, etc.

### Example 2

### A Schedulable Network-Enabled Device Including a Visual Data Delivery Unit

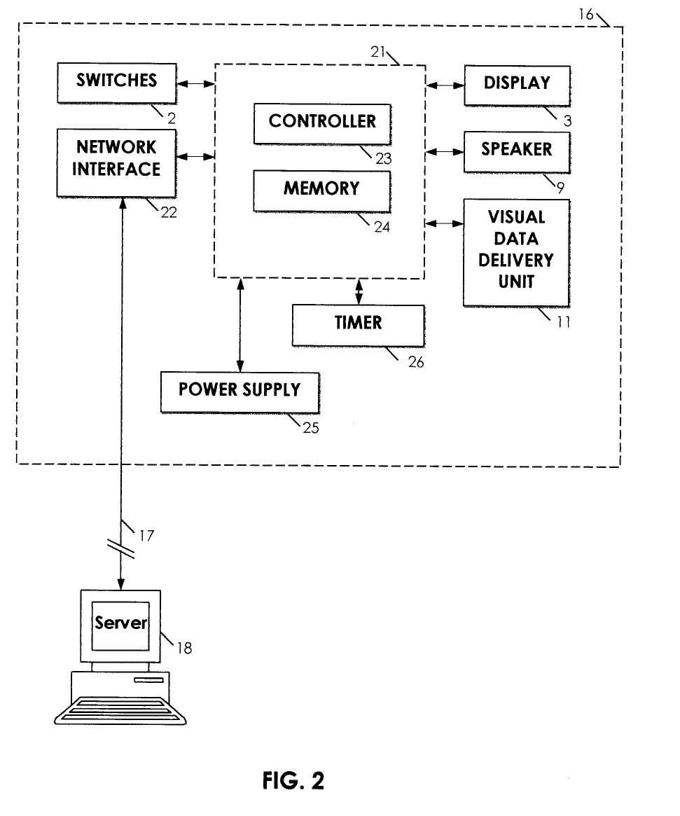

FIG. 2 is a simplified electronic schematic drawing of a self-contained schedulable network-enabled device with internal data delivery unit according to an embodiment of the present invention. The housing 16 contains switches 2, a display 3, a speaker 9, and external data source 18 as previously discussed. 21 is a data bus and power line used by all components for communication with one another. 26 is a schedulable timer. The device receives regulated power from a power supply 25 using AC current, or battery as its power source. 11 is a visual delivery unit used to provide operator with visual representation of desired data that has been downloaded from 18 via 17. 11 can be, for example but not limited to, a printer, liquid crystal display, cathode ray tube, light projector, transmitter or connection port for delivery of data to external medium, such as LCD screen found on current personal digital assistants, or electronic paper, such as that manufactured by E-Ink technologies.

### Example 3

### A Suitable Printer for the Schedulable Network-Enabled Device

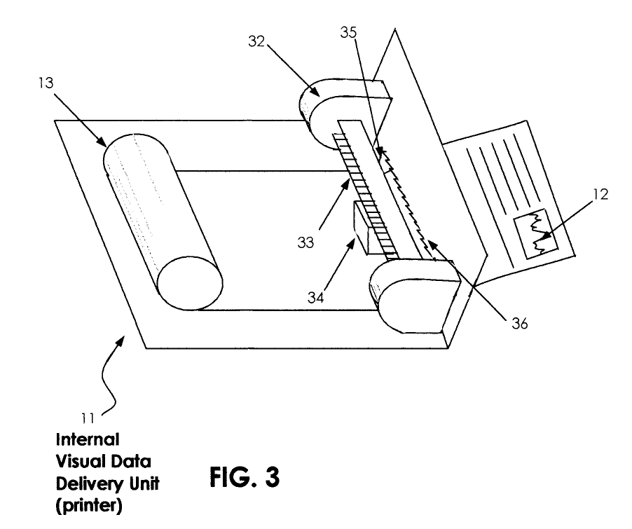

FIG. 3 is a simplified schematic of one embodiment of a printer 11 suitable for use in the apparatus 1 of FIG. 1. The printer may be for example SiPix® 400 dots-per-inch compact thermal printer, model Pocket Printer A6. The heat-sensitive recording medium 13 is stored in the form of a roll and is fed past a thermal print head 34 by a mechanism such as motor driven platen rollers (not shown). The print head 34 is attached to a belt 33, which is driven by a bi-directional motor 32 such that it 34 scans across the medium as dictated by printer control circuitry (not shown). The printed medium 13 is passed through an opening 35 where the user can use a sharp object 36 attached the housing to separate desired printed data 12 from stored supply of medium 13. Although the housing 16 is preferably a single housing, it could also consist of separable connectable units. For example, the printing unit could be disposed in a separate housing that is attachable and detachable from the alarm clock housing.

### Example 4

### A Method of Retrieving Specific Information from a Network

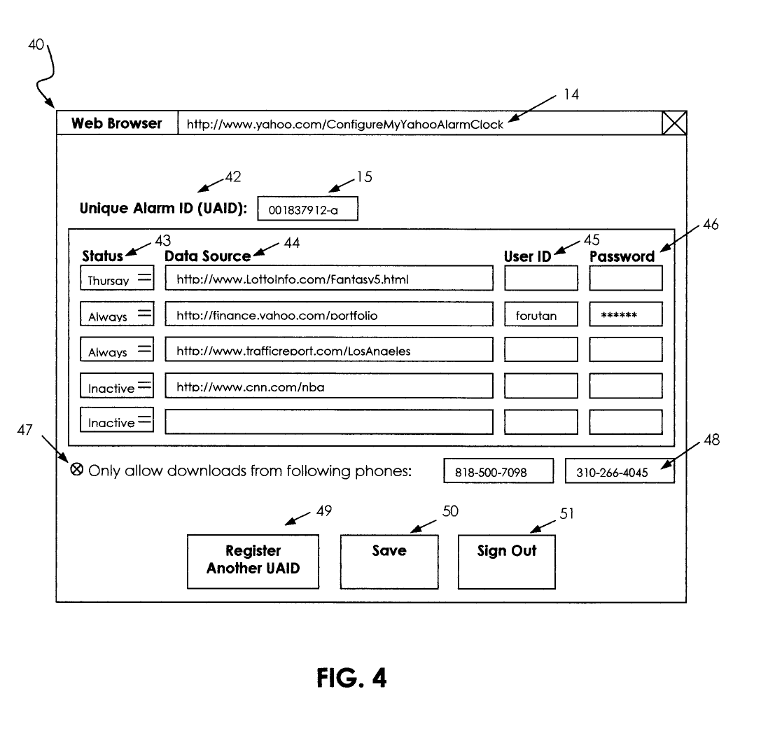

FIG. 4 depicts a sample user interface used by user in one method of operation for registering sources of desired information with server 14. In this example, user uses the web browser 40 of some PC connected to the Internet (not shown) to contact server 14. After creating and account or logging into existing account, user can begin selecting news sources for a given UAID. User enters a UAID 42 and for each desired data source enters the status 43 and URL address 44. Status 43 relates to when a server should deliver data to alarm clock device when alarm clock contacts server for UAID's data. In this example, the user has setup the server to always provide the alarm device with stock and traffic information, but only provide lottery numbers if device connects on a Thursdays. Until made “active”, server will not provide NBA scores from “cnn.com”. 45 and 46 are provided so proxy server 14 can identify the user to data servers 44 when attempting to retrieve the desired data. In this example, the proxy server will attempt to retrieve the current value of user “bforutan” stock portfolio as managed by data server “yahoo.com”. Note that the source for the desired financial data is “yahoo.com”, the same base web address as the proxy server where the UAIDs have been registered 14. There is no requirement that the data servers 44 and the proxy server 14 be the same or different.

For authentication purposes, so no two individuals attempt to register information for the same UAID, the user has the option 47 to provide the proxy server with a list of phone numbers 48, Internet Protocol (IP) addresses, or other unique network address that his alarm device may possibly contact the server from. Armed with the UAID and information as to what address the alarm clock has initiated the connection from, the server 14 is able to uniquely identify the true owner of the alarm clock requesting the data registered to the UAID.

When the network address of all web pages whose contents are to be downloaded and printed for a given alarm with associated UAID have been entered into registration program whose graphical user interface 40 is shown, the user must save values by pressing 50. Additional UAIDs can be registered and assigned data sources by pressing 49 and repeating the above process. Once all UAIDs are registered, user can sign out 51 of account.

### Example 5

### A Schedulable Network-Enabled Device Including an Internal Projector

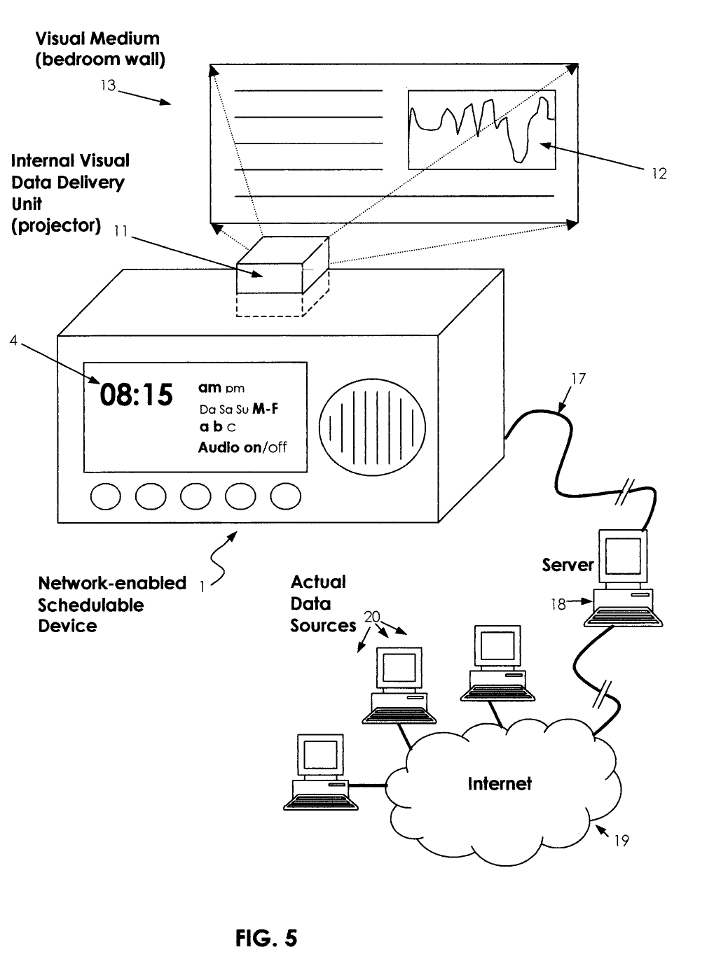

In FIG. 5, an embodiment of the invention is illustrated in simplified schematic form for the purpose of describing the basic concepts of the invention. At some scheduled time 4, the apparatus 1 is shown executing a projection sequence of text and image data 12 on a surface 13 such as a wall or screen, using a projector as its internal data deliveryunit 11. The data being projected was retrieved from data servers 20 over some network 19 by the remote proxy server 18 and delivered to the apparatus 1 over connection 17.

### Example 6

### A Schedulable Network-Enabled Device Including a Visual Data Delivery Unit For Use With Removable LCD

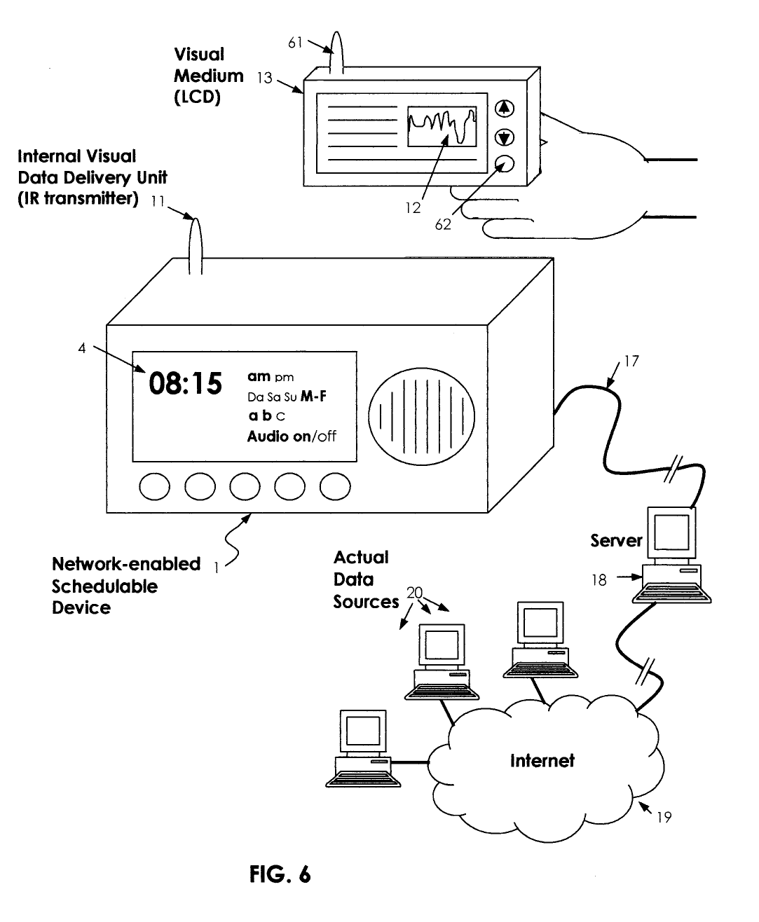

In FIG. 6, an embodiment of the invention is illustrated in simplified schematic form for the purpose of describing the basic concepts of the invention. At some scheduled time 4, the apparatus 1 is shown executing a delivery sequence of text and image data 12 to electronic medium 13 with data port 61 and navigation keys 62, such as a self-powered LCD display or electronic paper, such as that produced by E-INK corporation, using a wireless transmitter as its internal data deliveryunit 11. The data being projected was retrieved from data servers 20 over some network 19 by the remote proxy server 18 and delivered to the apparatus 1 over connection 17.

While the invention is described and illustrated herein with reference to a particular alarm device design, such description is exemplary in nature. Those skilled in the art will appreciate that the present invention can be used with many different types of alarm devices and timers with many different types of output devices used to display data downloaded from an external data source at a user scheduled time in accordance with the invention.

All headings are for the convenience of the reader and should not be used to limit the meaning of the text that follows the heading, unless so specified. Various changes and departures may be made to the present invention without departing from the spirit and scope thereof. Accordingly, it is not intended that the invention be limited to that specifically described in the specification or as illustrated in the drawings, but only as set forth in the claims.

What is claimed is:

1. A schedulable device comprising:
a housing;
a power supply
a schedulable timer;
memory means;
an internal visual means for displaying of information comprising an internal data delivery unit and a visual medium;
a network interface unit connected to a network; and
a central processing unit interconnected to said power supply, said schedulable timer, said memory means, said means for displaying information, and said network interface unit;
wherein, at a preset time, said schedulable timer triggers said central processing unit to cause said network interface unit to retrieve specified data from a remote server through said network and download said specified data in said memory means and deliver said specified data to be displayed on said visual medium by way of said internal data delivery unit.

2. The schedulable device of claim 1, further comprising an alarm clock having an audible alarm.

3. The schedulable device of claim 1, wherein said schedulable timer is able to be set to trigger an event at a future time or trigger an event instantaneously.

4. The schedulable device of claim 1, wherein said network interface unit connects to said network wirelessly.

5. The schedulable device of claim 1, wherein said central processing unit is able to resize incoming data from said remote server and present said resized data on said means for displaying of information.

6. The schedulable device of claim 1, wherein said visual medium is portable.

7. The schedulable device of claim 1, further comprising of one or more audiovisual means.

8. The schedulable device of claim 1, wherein said network interface unit is connected to a phone line and said network interface unit detects the area code of said phone line and connects to said remote server in the least expensive manner.

9. The schedulable device of claim 1, further comprising a unique identification number to facilitate customizable data retrieval.

10. The schedulable device of claim 1, wherein said means for displaying of information comprises a printing unit.

11. The schedulable device of claim 10, wherein said printing unit comprises 400×400 dots per inch thermal printer for use with loadable rolled A6 size paper.

12. The schedulable device of claim 1, wherein said means for displaying of information comprises a liquid crystal display.

13. The schedulable device of claim 12, wherein said liquid crystal display comprises a self-powered removable unit including memory and optionally one or more keys for scrolling.

14. The schedulable device of claim 1, wherein said means for displaying of information comprises a projector.

15. The schedulable device of claim 1, wherein said means for displaying of information comprises of electronic paper.

16. A method of retrieving specific information from a network comprising the steps of:
a) providing the schedulable device of claim 1, optionally including an alarm clock;
b) providing one or more unique identification numbers, wherein said central processing unit identifies itself to said remote server using said unique identification number(s) and said server queries its records for the data associated with said unique identification number(s) and provides said data to be downloaded by said schedulable device;
c) downloading said data from said remote server; and
d) displaying said data on said means for displaying information.

17. The method of claim 16, further comprising the step of registering said one or more unique identification numbers as associated with a particular phone number or network address for authentication purposes.

18. The method of claim 16, wherein said network interface unit of said schedulable device connects to said network wirelessly.

19. The method of claim 16, wherein said means for displaying of information of said schedulable device comprises a printing unit.

20. The schedulable device of claim 19, wherein said printing unit comprises 400×400 dots per inch thermal printer for use on rolled A6 size paper.

21. The method of claim 16, wherein said means for displaying of information of said schedulable device comprises a liquid crystal display.

22. The schedulable device of claim 21, wherein said liquid crystal display comprises a self-powered removable unit including memory and optionally one or more keys for scrolling.

23. The method of claim 16, wherein said means for displaying of information of said schedulable device comprises a projector.

24. The method of claim 16, wherein said means for displaying of information of said schedulable device comprises electronic paper.

25. The method of claim 16, wherein said the visual medium is portable.

26. A method of retrieving specific formation from a network comprising the steps of:
a) providing the schedulable device of claim 1 optionally including an alarm clock;
b) connecting said schedulable device to a personal computer in order to program said schedulable device with sources of desired information; wherein, said schedulable device utilizes programmed sources to connect to a remote server;
c) downloading said data from said remote server; and
d) displaying said data on said means for displaying information.

27. The method of claim 26, wherein said network interface unit of said schedulable device connects to said network wirelessly.

28. The method of claim 26, wherein said means for displaying information of said schedulable device comprises a printing unit.

29. The schedulable device of claim 28, wherein said printing unit comprises 400×400 dots per inch thermal printer for use with loadable rolled A6 size paper.

30. The method of claim 26, wherein said means for displaying of information of said schedulable device comprises a liquid crystal display.

31. The schedulable device of claim 30, wherein said liquid crystal display comprises a self-powered removable unit including memory and optionally one or more keys for scrolling.

32. The method of claim 26, wherein said means for displaying of information of said schedulable device comprises a projector.

33. The method of claim 26, wherein said means for displaying of information of said schedulable device comprises electronic paper.

34. The method of claim 26, wherein said the visual medium is portable.
